(19) United States
(12) Patent Application Publication
(10) Pub. No.: US 2026/0343159 A1
(43) Pub. Date: Oct. 29, 2026

(54) HEARING AID DEVICE

(71) Applicant: Luxshare Intelligent Manufacturing Electronic Services (Kunshan) Co., Ltd., Kunshan City Suzhou (CN)

(72) Inventors: Rongjin ZHANG, Kunshan City Suzhou (CN); Shutong JIANG, Kunshan City Suzhou (CN)

(73) Assignee: Luxshare Intelligent Manufacturing Electronic Services (Kunshan) Co., Ltd., Kunshan City Suzhou (CN)

(21) Appl. No.: 19/325,637

(22) Filed: Sep. 11, 2025

(30) Foreign Application Priority Data
Apr. 25, 2025 (CN) 202510533823.9

(51) Int. Cl. H04R 25/00

(52) U.S. Cl. CPC H04R 25/602; H04R 25/603; H04R 25/604; H04R 25/609; H04R 25/65; H04R 2225/51; H04R 2225/57; H04R 2225/61

(57) ABSTRACT

A hearing aid device includes a shell, a support structure, a battery assembly and a mainboard assembly. The shell includes a first housing and a second housing. The first housing and the second housing form an accommodation cavity. The support structure is disposed within the accommodation cavity and is provided with a semi-groove. The mainboard assembly includes a mainboard body and an extension structure which are connected to each other, the mainboard body is disposed on the support structure, one end of the extension structure is connected to the mainboard body, the other end of the extension structure is bent in a direction towards the battery assembly, the extension structure cooperates with the semi-groove to form a limit space for limiting the battery assembly, and the extension structure and/or the mainboard assembly are electrically connected to the battery assembly.

### CROSS-REFERENCE TO RELATED APPLICATION(S)

This application claims priority to Chinese Patent Application No. 202510533823.9 filed Apr. 25, 2025, the disclosure of which is incorporated herein by reference in its entirety.

### TECHNICAL FIELD

The present disclosure relates to the technical field of hearing aid devices, and in particular, to a hearing aid device.

### BACKGROUND

The hearing aid is a tool, apparatus, device, instrument, etc. that helps people with hearing impairments improve their auditory abilities and thus enhances their conversational and social skills with others. The hearing aid amplifies relatively faint sounds and transmits amplified sounds into the ear canal of the patient, thereby enabling the patient to hear faint sounds.

In the related art, the hearing aid generally includes a shell, an antenna assembly, a battery, a circuit board assembly, a speaker assembly and the like. The antenna assembly, the battery, the circuit board assembly and the speaker assembly are electrically connected as required. The antenna assembly, the battery and the circuit board assembly are disposed within the shell, and the speaker assembly is disposed on the shell. In order to prevent the battery within the shell from shaking relative to the shell, the battery needs to be limited by means of a battery support structure. Due to the arrangement of the battery support structure, the overall dimension and weight of the hearing aid are relatively large. Since the hearing aid needs to be worn on the ears for a long time, the requirements for miniaturization and lightweight of the hearing aid are relatively high. Therefore, it can be seen that the hearing aid in the related art has room for improvement in terms of dimension and weight.

Therefore, there is an urgent need for a hearing aid device to solve the above-described technical problems.

### SUMMARY

The present disclosure provides a hearing aid device, to solve the technical problems of large dimension and heavy weight in the related art.

A hearing aid device includes a shell, a support structure, a battery assembly and a mainboard assembly. The shell includes a first housing and a second housing, where the first housing and the second housing are connected to each other to form an accommodation cavity. The support structure is disposed within the accommodation cavity and is provided with a semi-groove. At least part of the battery assembly is located in the semi-groove. The mainboard assembly includes a mainboard body and an extension structure, where the mainboard body is disposed on the support structure, one end of the extension structure is connected to the mainboard body, and the other end of the extension structure is bent in a direction towards the battery assembly, the extension structure cooperates with the semi-groove to form a limit space for limiting the battery assembly, and the extension structure and/or the mainboard assembly are electrically connected to the battery assembly.

In an embodiment, the mainboard body is disposed on a side of the battery assembly in a first direction, the extension structure is provided with an output terminal, the output terminal is located on another side of the battery assembly in the first direction and is configured to be electrically connected to a charging terminal of the hearing aid device, and every two of the first direction, a width direction of the shell and a thickness direction of the shell are perpendicular to each other.

In an embodiment, the extension structure extends in a circumferential direction of the battery assembly, and/or the support structure is provided with a first enclosure barrier opposite to the battery assembly in a second direction and a second enclosure barrier extending in the circumferential direction of the battery assembly, the first enclosure barrier and the second enclosure barrier cooperate with each other to form the semi-groove, and the second direction is a thickness direction of the battery assembly.

In an embodiment, the support structure is provided with a limit structure, and the mainboard body is connected to the support structure through the limit structure.

In an embodiment, each of two sides of the support structure in a thickness direction of the support structure is provided with a limit structure, the mainboard body includes a body portion and two side plate portions, the extension structure is connected to the body portion, the two side plate portions are connected to the body portion and are disposed on the two sides of the support structure in the thickness direction of the support structure, and each of the two side plate portions is connected to the limit structure on a respective one of the two sides of the support structure.

In an embodiment, the hearing aid device further includes an antenna assembly, where the antenna assembly is disposed on the support structure and is electrically connected to the mainboard assembly.

In an embodiment, the hearing aid device further includes an elastic structure, where the elastic structure abuts against the antenna assembly and the mainboard assembly, and the antenna assembly is electrically connected to the mainboard assembly through the elastic structure.

In an embodiment, the antenna assembly is provided with at least one external extension portion extending towards the support structure, at least one elastic structure is disposed between each external extension portion of the at least one external extension portion and the mainboard body, and each of the at least one elastic structure abuts against a respective extension portion of the at least one external extension portion and is electrically connected to the respective external extension portion.

In an embodiment, the hearing aid device further includes at least one microphone, where each of the at least one microphone corresponds to at least one sound hole on the shell, the at least one microphone is disposed within the shell, the mainboard assembly further includes a convergence portion connected to the mainboard body, and the at least one microphone is electrically connected to the convergence portion.

In an embodiment, the convergence portion includes a first connection arm and a second connection arm which are connected to each other, the first connection arm is electrically connected to the mainboard body, the second connection arm and the first connection arm are disposed at an included angle to each other, the second connection arm has a convergence surface, and the at least one microphone is electrically connected to the convergence surface. The support structure is provided with a first support portion and a first limit portion, the first connection arm is supported by the first support portion, the first limit portion is disposed on a side of the second connection arm facing away from the convergence surface, and a movable gap is formed between the first limit portion and the second connection arm.

### BRIEF DESCRIPTION OF THE DRAWINGS

In order to more clearly explain technical solutions in embodiments of the present disclosure, the drawings used for describing the embodiments of the present disclosure will be briefly introduced below. Apparently, the drawings to be introduced are merely the drawings of part of the embodiments of the present disclosure. For those of ordinary skill in the art, other drawings may also be obtained without creative labor according to the contents of the embodiments of the present disclosure and these drawings.

FIG. 1 is a schematic structural view of an antenna device according to an embodiment of the present disclosure;

FIG. 2 is a first exploded view of an antenna device according to an embodiment of the present disclosure;

FIG. 3 is a second exploded view of an antenna device according to an embodiment of the present disclosure;

FIG. 4 is a top view of an antenna device according to an embodiment of the present disclosure;

FIG. 5 is a sectional view taken along A-A of FIG. 4 according to the present disclosure;

FIG. 6 is a sectional view taken along B-B of FIG. 4 according to the present disclosure;

FIG. 7 is a schematic view showing the assembly of a mainboard assembly and an elastic structure according to an embodiment of the present disclosure;

FIG. 8 is a first schematic structural view of a support structure according to an embodiment of the present disclosure;

FIG. 9 is a second schematic structural view of a support structure according to an embodiment of the present disclosure;

FIG. 10 is a first schematic structural view of a mainboard assembly according to an embodiment of the present disclosure;

FIG. 11 is an enlarged view at D in FIG. 5 according to the present disclosure;

FIG. 12 is a first schematic structural view of an antenna assembly according to an embodiment of the present disclosure;

FIG. 13 is a second schematic structural view of an antenna assembly according to an embodiment of the present disclosure;

FIG. 14 is a schematic structural view of an elastic structure according to an embodiment of the present disclosure;

FIG. 15 is a schematic view of a first housing and a second housing according to an embodiment of the present disclosure;

FIG. 16 is a schematic view of a second housing according to an embodiment of the present disclosure;

FIG. 17 is a third exploded view of an antenna device according to an embodiment of the present disclosure; and

FIG. 18 is an enlarged view at C in FIG. 5 according to the present disclosure.

### DETAILED DESCRIPTION

In order to make the technical problems solved, the technical solutions adopted, and the technical effects achieved by the present disclosure clearer, the technical solutions of the present disclosure are further described below by way of specific embodiments in conjunction with the accompanying drawings. It is to be understood that the specific embodiments described herein are merely illustrative of the present disclosure and are not to be construed as limiting the present disclosure. It is to be further noted that, for the convenience of description, only some, but not all, of the features related to the present disclosure are shown in the drawings.

It is to be understood that the phrase “one embodiment” or “an embodiment” mentioned throughout the specification means that particular features, structures or characteristics related to the embodiments are included in at least one embodiment of the present disclosure. Therefore, the appearance of the phrase “in one embodiment” or “in an embodiment” in various places throughout the specification does not necessarily refer to the same embodiment. In addition, the particular features, structures, or characteristics may be combined in one or more embodiments in any suitable manner.

It is to be noted that similar reference numerals and letters represent similar items in the following drawings. Therefore, once an item is defined in one drawing, there is no need to further define and explain this item in the subsequent drawings.

In the description of the present disclosure, unless otherwise expressly specified and limited, the term “connected to each other”, “connected”, or “fixed” is to be construed in a broad sense, for example, as fixedly connected, detachably connected, or integrated; mechanically connected or electrically connected; directly connected to each other, indirectly connected to each other via an intermediary, internal connection between two elements, or interaction between two elements. For those of ordinary skill in the art, specific meanings of the preceding terms in the present disclosure may be understood based on specific situations.

In the present disclosure, unless otherwise expressly specified and limited, a first feature being “on” or “under” a second feature may include the first feature and the second feature being in direct contact, or may include the first feature and the second feature not being in direct contact but being in contact with each other through an additional feature therebetween. Moreover, the first feature being “on”, “above” or “over” the second feature includes the first feature being directly on, above or over and obliquely on, above or over the second feature, or simply represents that the first feature is at a higher level than the second feature. The first feature being “under”, “below” or “underneath” the second feature includes the first feature being directly under, below or underneath and obliquely under, below or underneath the second feature, or simply represents that the first feature is at a lower level than the second feature. In the description of this embodiment, unless otherwise specified, “multiple” specifically refers to two or more.

In the description of this embodiment, the orientational or positional relationships indicated by the terms such as “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial direction”, “radial direction”, and “circumferential direction” are based on the orientational or positional relationships shown in the drawings. These terms are merely for the convenience of description and simplification of operation, rather than indicating or implying that the referred device or element must have a specific orientation and must be constructed and operated in a specific orientation; therefore, they should not be construed as limiting the present disclosure. In addition, the terms “first” and “second” are merely used for distinguishing between descriptions and have no special meanings.

It is to be noted that when an element is referred to as being “fixed to” or “disposed on” another element, the element may be directly on another element or there may be an intermediate element in between.

The technical solutions of the present disclosure will be further described below in conjunction with the drawings and through specific embodiments.

This embodiment provides a hearing aid device. The hearing aid device may have a relatively small dimension and a relatively light weight, thereby satisfying the requirements of miniaturization.

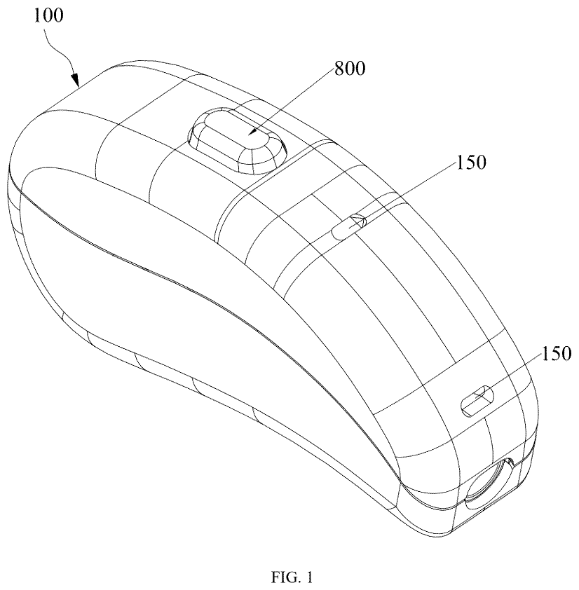

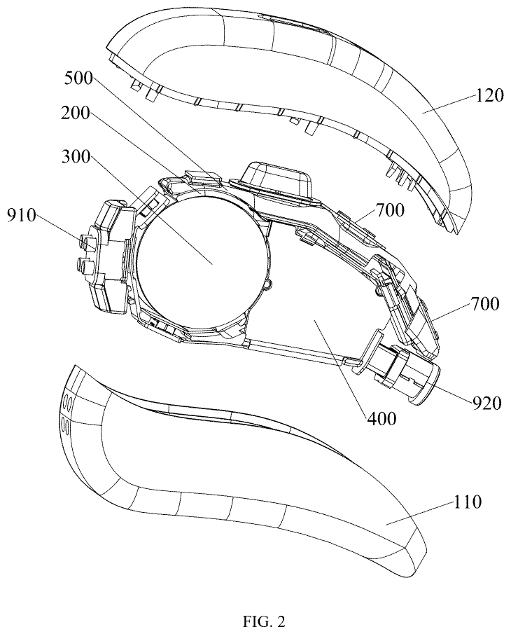

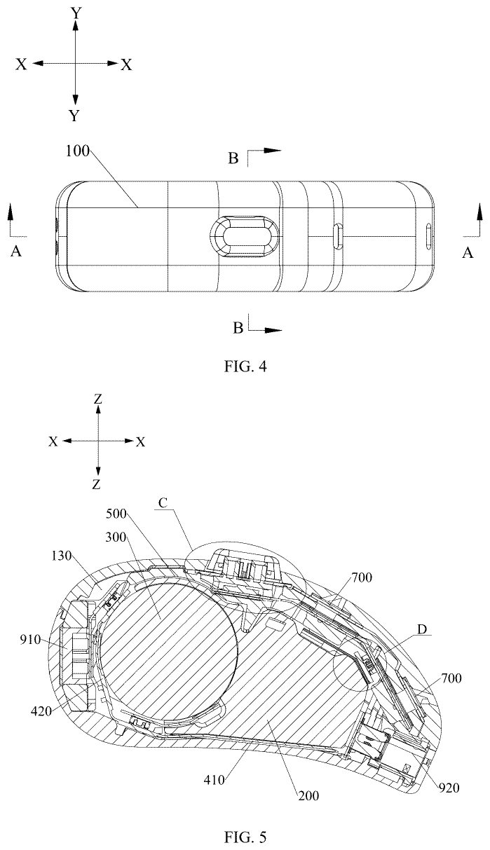

Exemplarily, as shown in FIGS. 1 to 18, the hearing aid device includes a shell 100. The shell 100 may include a first housing 110 and a second housing 120. The first housing 110 and the second housing 120 are connected to each other to form an accommodation cavity 130. The first housing 110 and the second housing 120, which are connected to each other, are provided, so that the assembly of the hearing aid device can be facilitated, thereby improving the assembly efficiency. It is to be noted that, in this embodiment, an example in which a housing located at a lower position in the orientation shown in FIG. 2 is the first housing 110 and a housing located at an upper position in the orientation shown in FIG. 2 is the second housing 120 is used for description. Of course, it is to be understood that a housing located at an upper position may also be the first housing 110, and a housing located at a lower position may be the second housing 120, which is not limited in this embodiment.

As shown in FIG. 2, the hearing aid device further includes a support structure 200 disposed within the accommodation cavity 130. The support structure 200 may serve as the main support structure inside the hearing aid device. The components within the hearing aid device may be directly disposed on the support structure 200, or the components within the hearing aid device may be disposed between the support structure 200 and the shell 100 to be limited by means of the support structure 200 and the shell 100, which is not limited in this embodiment. Exemplarily, as shown in FIG. 8, the support structure 200 is provided with a semi-groove 210.

As shown in FIG. 2, the hearing aid device further includes a battery assembly 300 and a mainboard assembly 400. The battery assembly 300 serves as the energy supply for the entire hearing aid device, to supply power to the mainboard assembly 400 and other electronic components. The mainboard assembly 400 is electrically connected to the battery assembly 300. At least part of the battery assembly 300 is located in the semi-groove 210 to be able to be limited by the support structure 200.

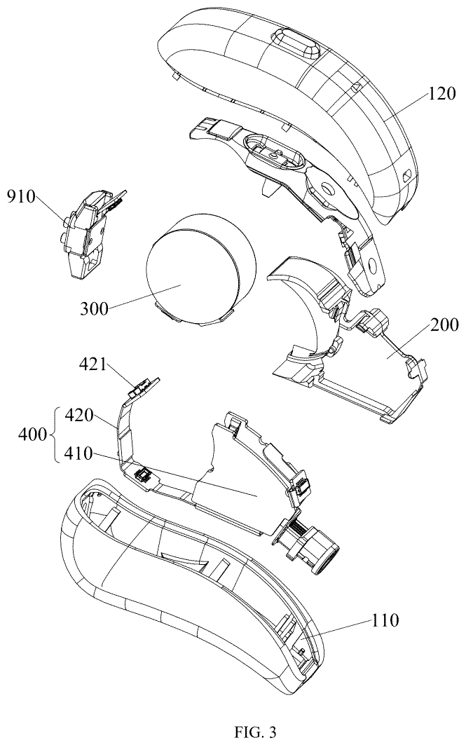

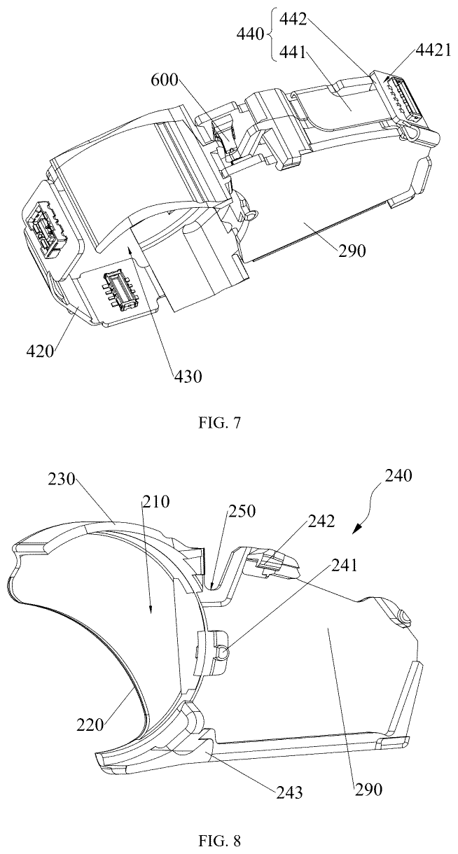

Exemplarily, as shown in FIG. 3, the mainboard assembly 400 includes a mainboard body 410 and an extension structure 420 which are connected to each other. The mainboard body 410 is electrically connected to the extension structure 420 and is disposed on the support structure 200. In this embodiment, as shown in FIG. 7, one end of the extension structure 420 is connected to the mainboard body 410, and the other end of the extension structure 420 is bent in a direction towards the battery assembly 300. The extension structure 420 cooperates with the semi-groove 210 to form a limit space 430 for limiting the battery assembly 300. The shape of the limit space 430 matches the shape of the battery assembly 300, to limit the movement of the battery assembly 300 relative to the extension structure 420 and the support structure 200. Moreover, the battery assembly 300 is electrically connected to the mainboard assembly 400, whereby the battery assembly 300 is limited in the shell 100. In this embodiment, the extension structure 420 and/or the mainboard assembly 400 are electrically connected to the battery assembly 300, thereby enabling the battery assembly 300 to supply power to the extension structure 420 and/or the mainboard assembly 400.

It is to be noted that, if the support structure 200 independently forms a groove for limiting the battery assembly 300, the size of the support structure 200 needs to be set to be greater than the size of the battery assembly 300, to achieve the purpose of limiting the battery assembly 300. Moreover, the mainboard body 410 surrounds the outer periphery of the support structure 200 to achieve the electrical connection with other electronic components. However, this arrangement results in the overall large dimension and the overall heavy weight for both the support structure 200 and the mainboard body 410.

In the hearing aid device provided in this embodiment, a part of the support structure 200 cooperates with a part of the mainboard assembly 400 to form the limit space 430 for limiting the battery assembly 300. Specifically, the mainboard assembly 400 includes the mainboard body 410 and the extension structure 420. One end of the extension structure 420 is connected to the mainboard body 410, and the other end of the extension structure 420 is bent towards the battery assembly 300. The extension structure 420 cooperates with the semi-groove 210 of the support structure 200 to form the limit space 430 for limiting the battery assembly 300. In this way, the extension structure 420 can not only be used for electrical connection with other electrical components, but also for limiting the battery assembly 300, whereby the utilization rate of the extension structure 420 is improved. The support structure 200 and the extension structure 420 jointly limit the battery assembly 300. Therefore, the size of the support structure 200 may be disposed to be less than the size of the battery assembly 300, so that the overall dimension and weight of the support structure 200 and the mainboard assembly 400 can be reduced, thereby making the hearing aid device more miniaturized and lightweight.

Of course, the hearing aid device further includes a key hearing aid component such as a microphone 700, a receiver, and a programming accessory. All these components are existing components of the hearing aid. For a specific structure, reference may be made to the existing hearing aid, which is not described in detail here. The key hearing aid component may be disposed inside the shell 100 as required, and may also be disposed outside the shell 100 in other manners, which are not described in detail here.

The battery assembly 300 in this embodiment generally includes a charging battery (not shown in the drawing) and a battery circuit board (not shown in the drawing) connected to the charging battery. The charging battery may be charged and discharged, so as to be able to be recycled. The battery circuit board is electrically connected to the positive and negative poles of the charging battery and is electrically connected to the mainboard assembly 400, to achieve the electrical connection between the charging battery and the mainboard assembly 400. The shape of the charging battery may be a circle, a square, and the like, which is not limited in this embodiment.

In some optional embodiments, the hearing aid device is further provided with a charging terminal 910, and the charging terminal 910 is electrically connected to the charging battery, so that the external power supply may charge the charging battery through the charging terminal 910. The charging terminal 910 may be a charging socket, or a wireless charging structure, or a common charging structure in the related art such as a contact-type charging structure, which is not limited in this embodiment.

Exemplarily, as shown in FIG. 3, the extension structure 420 is provided with an output terminal 421, and the output terminal 421 is configured to be electrically connected to the charging terminal 910, so that the charging terminal 910 is electrically connected to the charging battery through the extension structure 420. Optionally, the output terminal 421 of the extension structure 420 may be a circuit board. With such an arrangement, the extension structure 420 is not only configured to be electrically connected to the charging terminal 910, but also serves as the limit member to limit the battery assembly 300.

In order to optimize positions of the output terminal 421, the battery assembly 300 and the mainboard assembly 400, so that the hearing aid device is compact in size while meeting requirements, in this embodiment, as shown in FIG. 5, the mainboard body 410 is disposed on a side of the battery assembly 300 in a first direction X, and the output terminal 421 is located on the other side of the battery assembly 300 in the first direction X. Every two of the first direction X, a width direction of the shell 100, and a thickness direction of the shell 100 are perpendicular to each other. With such an arrangement, the output terminal 421, the battery assembly 300 and the mainboard body 410 are sequentially disposed in a direction approximately a length direction of the shell 100, thereby preventing the hearing aid device from being too thick or too wide, facilitating the use of the hearing aid device, and making the application range of the hearing aid device wider. In some optional embodiments, the first direction X may be the length direction of the shell 100.

Optionally, the charging terminal 910 is located at an end of the shell 100 facing the output terminal 421 in the first direction X, so that the charging terminal 910 is in close proximity to the output terminal 421, thereby facilitating the electrical connection between charging terminal 910 and the output terminal 421. In FIG. 5, the charging terminal 910 is disposed at the left end of the shell 100.

In some optional embodiments, as shown in FIG. 5, the extension structure 420 extends in a circumferential direction of the battery assembly 300, that is, the extension structure 420 limits the battery assembly 300 in a direction perpendicular to an axial direction of the battery assembly 300. The extension structure 420 is generally a circuit board in nature, and the circuit board may be a rigid circuit board or a flexible circuit board. In order to improve the limiting effect, the circuit board in this embodiment is the rigid circuit board. In this case, the extension structure 420 may be formed by assembling multiple sections of circuit boards, to conform to the shape of the battery assembly 300. Since the limiting of the battery assembly 300 in the axial direction can be achieved by the shell 100, the extension structure 420 in this embodiment is mainly configured to limit the battery assembly 300 in a direction perpendicular to the axial direction of the battery assembly 300. It is, of course, to be understood that the extension structure 420 may also limit the battery assembly 300 in the axial direction of the battery assembly 300, which is not limited in this embodiment.

Optionally, this embodiment provides a support structure 200. As shown in FIG. 8, the support structure 200 is provided with a first enclosure barrier 220 opposite to the battery assembly 300 in a second direction Y and a second enclosure barrier 230 extending in the circumferential direction of the battery assembly 300. The first enclosure barrier 220 and the second enclosure barrier 230 cooperate with each other to form the semi-groove 210, and the second direction Y in this embodiment is a thickness direction of the battery assembly 300.

The first enclosure barrier 220 is provided to block the battery assembly 300 in the second direction Y. It is to be noted that, the first enclosure barrier 220 is disposed on one side or two sides of the battery assembly 300 in the second direction Y, which is not limited in this embodiment. FIG. 8 is a schematic diagram showing that the first enclosure barrier 220 is disposed on a side of the battery assembly 300 in the second direction Y. In this case, the other side of the battery assembly 300 in the second direction Y may be limited by the shell 100, so that the structure of the support structure 200 is relatively small and the weight of the support structure 200 is relatively light. The second enclosure barrier 230 is provided so that the second enclosure barrier 230 may cooperate with the extension structure 420 to limit the battery assembly 300, thereby preventing the battery assembly 300 from moving.

In some optional embodiments, with continued reference to FIG. 8, the support structure 200 further includes a support plate 290. The first enclosure barrier 220 and the second enclosure barrier 230 are both connected to the support plate 290. Optionally, the second enclosure barrier 230 may be formed by multiple block bodies, and the multiple block bodies are disposed at intervals in the circumferential direction of the battery assembly 300, so that the weight of the second enclosure barrier 230 may be relatively light on the basis of limiting the battery assembly 300.

The mainboard body 410 may be disposed in various manners. This embodiment provides a manner for disposing the mainboard body 410. Optionally, as shown in FIG. 8, the support structure 200 is provided with a limit structure 240, and as shown in FIG. 7, the mainboard body 410 is disposed on the support structure 200 and is connected to the support structure 200 through the limit structure 240. The mainboard body 410 is disposed on the support structure 200, so that the mainboard body 410 may be supported without separately providing a support component, thereby reducing the number of components in the hearing aid device and facilitating the assembly of the hearing aid device. The connection between the mainboard body 410 and the support structure 200 is achieved by the limit structure 240, so that the dimension of the support structure 200 can be reduced, thereby facilitating the miniaturization of the support structure 200.

Further optionally, each of two sides of the support structure 200 in a thickness direction of the support structure 200 is provided with a limit structure 240. As shown in FIG. 10, the mainboard body 410 includes a body portion 411 and two side plate portions 412. The two side plate portions 412 are located on the same side of the body portion 411. The extension structure 420 is connected to the body portion 411, that is, the extension structure 420 is electrically connected to the body portion 411. The two side plate portions 412 are electrically connected to the body portion 411 and are disposed on the two sides of the support structure 200 in the thickness direction of the support structure 200, and each of the two side plate portions 412 is connected to the limit structure 240 on a respective one of the two sides of the support structure 200, that is, the side plate portion 412 located on one side of the support structure 200 is connected by the limit structure 240 on the one side, and the side plate portion 412 located on the other side of the support structure 200 is connected by the limit structure 240 on the other side, thereby achieving the fixation of the two side plate portions 412. Optionally, when the support structure 200 includes the support plate 290, the limit structure 240 is disposed on the support plate 290, and the support plate 290 is fixed in the space formed by the body portion 411 and the two side plate portions 412.

It is to be noted that in order to improve the space utilization rate of space inside the shell 100, the thickness direction of the shell 100, the thickness direction of the battery assembly 300, the thickness direction of the support structure 200, and a thickness direction of the mainboard body 410 are consistent.

In an optional embodiment, as shown in FIG. 10, the side plate portion 412 is provided with a limit-fit structure 4121. The limit-fit structure 4121 cooperates with the limit structure 240 to achieve the connection between the mainboard body 410 and the support structure 200, for example, the limit structure 240 may be connected to the limit-fit structure 4121 by means of snap-fitting, interference fit and the like. The limit-fit structure 4121 is provided so that the structure connected to the side panel portion 412 is simplified, and the assembly of the side panel portion 412 with the support structure 200 is also facilitated.

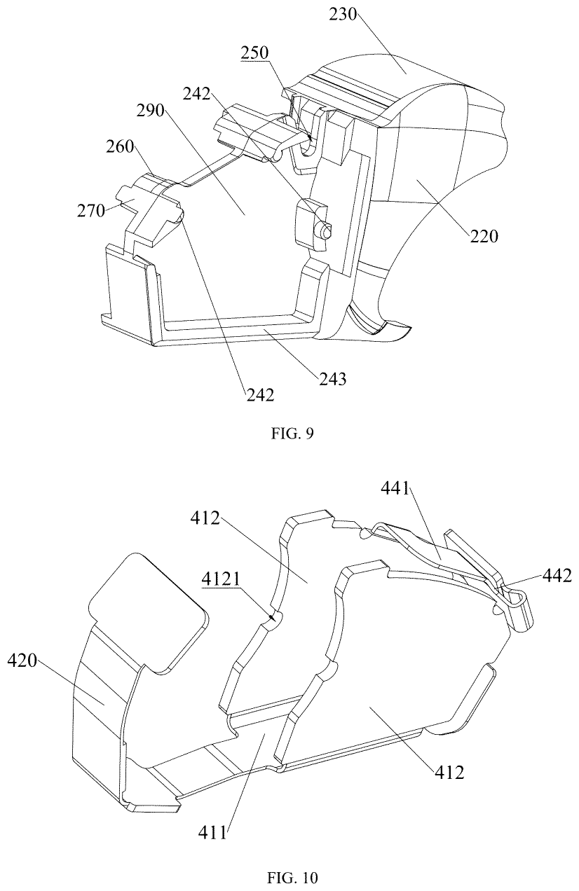

The limit structure 240 may have a variety of structures, as long as it can achieve the purpose of limiting. In one embodiment, as shown in FIGS. 8 and 9, each side surface of the support plate 290 may include multiple limit structures 240. Some of the multiple limit structures 240 may be limit posts 241, some of the multiple limit structures 240 may be limit hooks 242, and some of the multiple limit structures 240 may be the limit blocks 243, which is not limited in this embodiment. When the limit structure 240 is the limit post 241, the limit-fit structure 4121 may be the limit groove. The limit post 241 is snap-fit with the limit groove, to achieve the connection between the mainboard body 410 and the support structure 200. When the limit structure 240 is the limit hook 242, the limit-fit structure 4121 may be the limit groove, a limit plane, and the like. The limit hook 242 is hooked on the limit groove or the limit plane to achieve the connection between the mainboard body 410 and the support structure 200. When the limit structure 240 is the limit block 243, the limit-fit structure 4121 may be a block body disposed on the side plate portion 412. The limiting is achieved through the abutting between the limit block 243 and the block body, and further the connection is achieved. The limit structure 240 may have various specific structures and various limit manners, which are not listed one by one in this embodiment.

In order to make the hearing aid device provided in this embodiment more functionally rich, as shown in FIG. 2, the hearing aid device further includes an antenna assembly 500, and the antenna assembly 500 is disposed on the support structure 200. In some optional embodiments, the antenna assembly 500 is disposed on a side of the support structure 200 in a third direction Z. The third direction Z intersects the thickness direction of the support structure 200 and intersects the length direction of the shell 100. In the orientation shown in FIG. 5, the antenna assembly 500 is located above the support structure 200. The antenna assembly 500 is electrically connected to the mainboard assembly 400. In this embodiment, the antenna assembly 500 is electrically connected to the mainboard body 410. The antenna assembly 500 is configured to receive and/or transmit signals for communication between the hearing aid device and the outside world. It is to be noted that the antenna assembly 500 being disposed on the support structure 200 may be understood as the antenna assembly 500 being fixedly connected, detachably connected, and the like, to the support structure 200, which is not limited in this embodiment.

The antenna assembly 500 may be electrically connected to the mainboard assembly 400 in various manners. This embodiment provides a manner in which the antenna assembly 500 is connected to the mainboard assembly 400.

Exemplarily, as shown in FIG. 7, the hearing aid device further includes an elastic structure 600, and the antenna assembly 500 is electrically connected to the mainboard body 410 through the elastic structure 600. The elastic structure 600 abuts between the antenna assembly 500 and the mainboard assembly 400, and the antenna assembly 500 is electrically connected to the mainboard assembly 400 through the elastic structure 600.

In some optional embodiments, the elastic structure 600 in this embodiment is capable of elastic deformation, and the elastic structure 600 may elastically abut between the antenna assembly 500 and the mainboard assembly 400, so that the requirement of the distance between the antenna assembly 500 and the mainboard assembly 400 can be reduced, and thus the requirement of the assembly precision of the antenna assembly 500 and the mainboard assembly 400 and the difficulty of assembling the antenna assembly 500 and the mainboard assembly 400 can be reduced, thereby improving the assembly efficiency of the hearing aid device. Moreover, the elastic structure 600 is capable of deformation, and thus a position where the elastic structure 600 elastically abuts against the antenna assembly 500 or the mainboard assembly 400 may be a relatively flexible region, thereby reducing the requirement for the relative position of the antenna assembly 500 and the mainboard assembly 400.

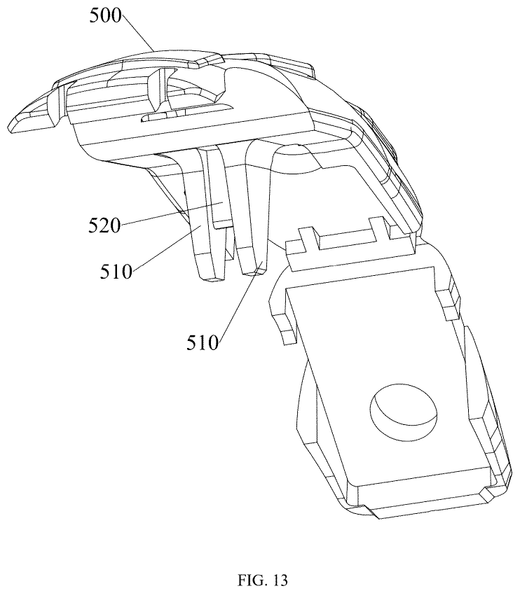

In some optional embodiments, as shown in FIGS. 12 and 13, the antenna assembly 500 is provided with at least one external extension portion 510 extending towards the support structure 200. At least one elastic structure 600 is disposed between each external extension portion of the at least one external extension portion 510 and the mainboard body 410. The elastic structure 600 abuts against a corresponding external extension portion 510 and is electrically connected to the corresponding external extension portion 510, thereby achieving that electrical connection between each external extension portion 510 and the mainboard assembly 400. The external extension portion 510 is provided to facilitate the electrical connection between the antenna assembly 500 and the mainboard body 410 via the elastic structure 600.

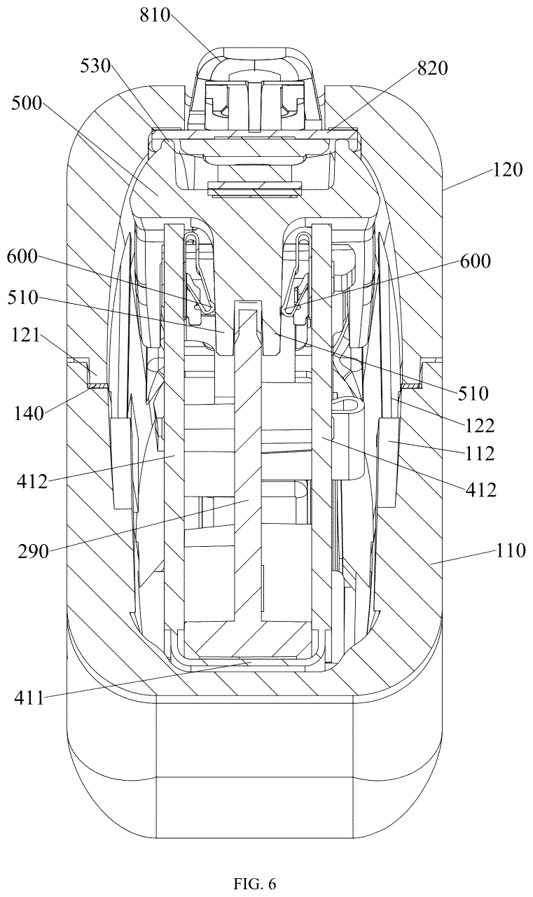

As shown in FIG. 6, two elastic structures 600 are provided, and the two elastic structures 600 correspondingly abut against the two side plate portions 412 and abut against opposite surfaces of the two side plate portions 412. Further exemplarily, two external extension portions 510 are provided, and the two external extension portions 510 are disposed opposite to each other in the thickness direction of the mainboard body 410. The two elastic structures 600 abut against the two external extension portions 510 in one-to-one correspondence, thereby achieving the electrical connection between the antenna assembly 500 and the mainboard body 410. The two elastic structures 600 are provided, so that the area of electrical connection and the strength of electrical connection between the antenna assembly 500 and the mainboard body 410 are improved.

Further optionally, as shown in FIG. 8 or FIG. 9, the support structure 200 is provided with a positioning clamping groove 250, and correspondingly, referring to FIG. 13, a positioning clamping block 520 is disposed between the two external extension portions 510, and the positioning clamping block 520 is positioned in the positioning clamping groove 250, that is, the shape of the positioning clamping groove 250 matches the shape of the positioning clamping block 520 to enable the support structure 200 to position the antenna assembly 500 through the positioning clamping groove 250 and the positioning clamping block 520 cooperating with each other, and further to limit the relative position of the antenna assembly 500 and the support structure 200. Since the position of the mainboard body 410 relative to the support structure 200 is certain, the relative position between the antenna assembly 500 and the support structure 200 is limited, so that the relative position between the antenna assembly 500 and the mainboard body 410 can be restricted, thereby facilitating the electrical connection between the antenna assembly 500 and the mainboard body 410.

In this embodiment, as shown in FIG. 6, the two external extension portions 510 are in corresponding contact with the two side walls in the thickness direction of the support structure 200, specifically, the two external extension portions 510 are in corresponding contact with the two side walls in a thickness direction of the support plate 290. With such an arrangement, the two external extension portions 510 are in a clamping state with the support plate 290, thereby restricting the position of the antenna assembly 500 in the thickness direction of the support plate 290 relative to the support plate 290, and thus limiting the antenna assembly 500.

The antenna assembly 500 in this embodiment is disposed on the support structure 200, and the support structure 200 is also configured to limit the battery assembly 300 and the mainboard assembly 400, so that the fixing of the antenna assembly 500, the battery assembly 300, and the mainboard assembly 400 inside the shell 100 can be achieved by the support structure 200, thereby improving the utilization rate of the support structure 200, enriching the function of the support structure 200, reducing the number of support structures 200 that need to be provided within the shell 100, and further improving the miniaturization and lightweight of the hearing aid device.

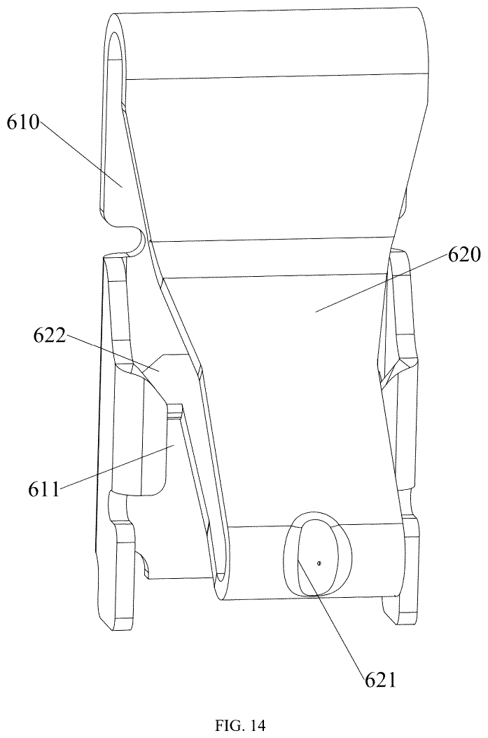

Optionally, there are various types of elastic structures 600. This embodiment provides an elastic structure 600, as shown in FIG. 14, the elastic structure 600 includes an elastic piece body 610 and a bent portion 620. The bent portion 620 is connected to an end of the elastic piece body 610 and is located on a side of the elastic piece body 610. The elastic piece body 610 abuts against one of the external extension portion 510 of the antenna assembly 500 and the mainboard assembly 400. The bent portion 620 has an abutting arc surface 621 that abuts against the other of the mainboard assembly 400 and the external extension portion 510. The abutting arc surface 621 is provided to enable the arc surface contact with the external extension portion 510 of the antenna assembly 500 or the mainboard body 410, thereby reducing the risk of damage to the antenna assembly 500 or the mainboard body 410 and enhancing the reliability. In some optional embodiments, the abutting arc surface 621 may be formed by bending the bent portion 620. In other embodiments, the abutting arc surface 621 may also be formed by machining a spherical projection on the bent portion 620, which is not limited in this embodiment.

In order to increase the force with which the bent portion 620 abuts against the antenna assembly 500 or the mainboard body 410, in this embodiment, with continued reference to FIG. 14, a sliding groove 611 is disposed on a side of the elastic piece body 610 towards the bent portion 620. An end of the bent portion 620 facing away from the elastic piece body 610 (i.e., an end of the bent portion 620 not connected to the elastic piece body 610) is provided with a sliding block 622 that abuts against the elastic piece body 610. The sliding block 622 is slidably disposed in the sliding groove 611. When the distance between the antenna assembly 500 and the mainboard body 410 varies, the elastic structure 600 may slide in the sliding groove 611 through the sliding block 622, to adjust the distance between the abutting arc surface 621 of the bent portion 620 and the elastic piece body 610, and further adjust the height of the elastic structure 600, so that the bent portion 620 of the elastic structure 600 smoothly abuts against the antenna assembly 500 or the mainboard body 410. It can be seen that the elastic structure 600 provided in this embodiment has the wider application range, the stronger universality, and the simper structure.

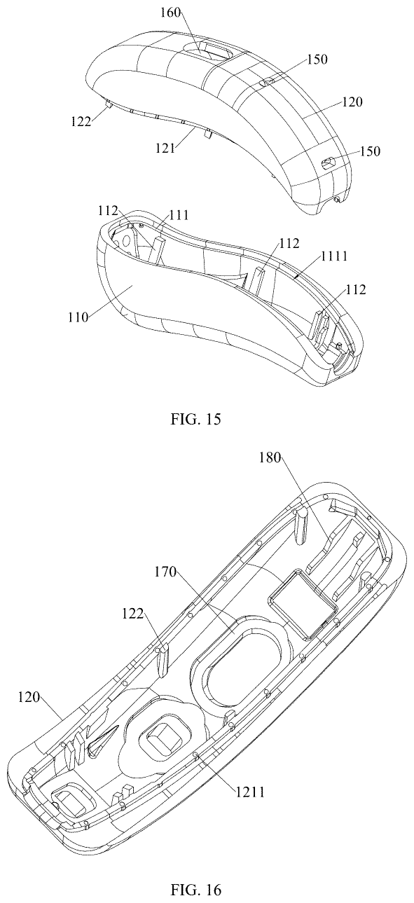

In order to improve the waterproof performance of the hearing aid device provided in this embodiment, in this embodiment, as shown in FIG. 15, the first housing 110 is provided with a stepped structure 111, the second housing 120 is provided with a boss 121 that mates with the stepped structure 111, and the boss 121 is configured to be inserted into the stepped structure 111 to achieve the limiting between the first housing 110 and the second housing 120. Moreover, the stepped structure 111 includes a stepped surface 1111 and a stepped side surface, the stepped side surface abuts against a side surface of the boss 121, thereby limiting the relative position of the first housing 110 and the second housing 120 in a wall thickness direction of the first housing 110. As shown in FIG. 6, a sealing colloid 140 is disposed between the stepped surface 1111 of the stepped structure 111 and the boss 121, and the sealing colloid 140 is configured to seal a gap between the stepped surface 1111 and a top surface of the boss 121, thereby achieving the sealing at a connection position of the first housing 110 and the second housing 120 and improving the waterproof performance of the shell 100.

Exemplarily, the sealing colloid 140 is generally hot-melt adhesive. When the sealing colloid 140 is formed, it is necessary to perform the adhesive dispensing on the stepped surface 1111 or the top surface of the boss 121 first. Then, the first housing 110 and the second housing 120 are butted against each other, and the adhesive is tightly squeezed so that the adhesive is filled between the stepped surface 1111 and the top surface of the boss 121. After that, let it stand for seven or eight hours. Once the adhesive is cured, the connection and sealing between the first housing 110 and the second housing 120 are achieved.

In order to ensure that a sufficient amount of adhesive exists between the stepped surface 1111 and the top surface of the boss 121, in this embodiment, as shown in FIG. 16, a surface of the boss 121 towards the first housing 110 (i.e., the top surface of the boss 121) is provided with a support protrusion 1211. The support protrusion 1211 is provided, so that during the adhesive dispensing, the amount of adhesive may be controlled with reference to the support protrusion 1211. Specifically, the adhesive may be controlled to completely cover the support protrusion 1211 to ensure the height of the adhesive dispensing. This, in turn, ensures the amount of adhesive between the first housing 110 and the second housing 120, thereby ensuring the connection strength and the sealing performance between the first housing 110 and the second housing 120.

Optionally, multiple support protrusions 1211 are provided, and the multiple support protrusions 1211 are disposed uniformly and at intervals in a circumferential direction of the second housing 120.

Since the sealing colloid 140 may only be obtained after performing the adhesive dispensing and then standing for seven or eight hours, the hearing aid device cannot be moved to the next assembly station (or testing station) during the adhesive curing, resulting in relatively low production efficiency of the hearing aid device.

In response to the problem of low production efficiency, in this embodiment, the production efficiency can be improved by improving the first housing 110 and the second housing 120. Specifically, as shown in FIG. 15, an inner wall of the first housing 110 is provided with a first welding body 112, an inner wall of the second housing 120 is provided with a second welding body 122, and the first welding body 112 is welded to the second welding body 122 by ultrasonic welding. With such an arrangement, after the adhesive dispensing is completed on the first housing 110 and the second housing 120, a solder (such as solder paste) may be applied to the first welding body 112 and/or the second welding body 122. Then, the first housing 110 and the second housing 120 are buckled together. Thereafter, the first welding body 112 and the second welding body 122 are welded by ultrasonic welding, so that the first housing 110 and the second housing 120 are pre-fixed through the first welding body 112 and the second welding body 122 which are welded to each other. The first housing 110 and the second housing 112 will not move relative to each other. Therefore, the next process may be performed without waiting for the sealing adhesive to cure, thereby improving the production efficiency of the hearing aid device.

In order to enhance the pre-fixing strength between the first housing 110 and the second housing 120, in this embodiment, multiple first welding bodies 112 and multiple second welding bodies 122 are disposed in a one-to-one correspondence. Each first welding body 112 is welded to the second welding body 122 corresponding to the each first welding body 112 by ultrasonic welding.

If a connection position of the first welding body 112 and the second welding body 122 is closer to a bonding position of the first housing 110 and the second housing 120, the properties of the sealing colloid 140 may be affected during ultrasonic welding. In an optional embodiment, referring to FIGS. 6 and 15, the first welding body 112 extends into the second housing 120. With such an arrangement, a welding position of the first welding body 112 and the second welding body 122 is farther away from the sealing colloid 140, so that the properties of the sealing colloid 140 will not be affected during the ultrasonic welding, thereby ensuring that the sealing colloid 140 effectively seals and connects the first housing 110 and the second housing 120. Of course, it may also be that the second welding body 122 extends into the first housing 110, which is not limited in this embodiment.

Exemplarily, the hearing aid device further includes at least one microphone 700 disposed within the shell 100. The at least one microphone 700 is used for generating sound and transmitting the sound to the user's ear. The hearing aid device may be provided with one microphone 700 and may also be provided with multiple microphones 700, which is not limited in this embodiment. Moreover, as shown in FIG. 15, each microphone 700 corresponds to at least one sound hole 150 in the shell 100, thereby enabling the sound transmission. Exemplarily, the sound hole 150 is disposed on the second housing 120.

Optionally, as shown in FIG. 7, the mainboard assembly 400 further includes a convergence portion 440 connected to the mainboard body 410, and the at least one microphone 700 is electrically connected to the convergence portion 440. The convergence portion 440 is configured to converge the multiple microphones 700, thereby facilitating the electrical connection of the microphone 700 and the mainboard body 410.

In some optional embodiments, with continued reference to FIG. 7, the convergence portion 440 includes a first connection arm 441 and a second connection arm 442 connected in sequence. The first connection arm 441 is electrically connected to the mainboard body 410, specifically, one end of the first connection arm 441 is electrically connected to one side plate portion of the two side plate portions 412, and the other end of the first connection arm 441 is electrically connected to the second connection arm 442. The second connection arm 442 and the first connection arm 441 are disposed at an included angle to each other, so that an extension direction of the first connection arm 441 and an extension direction of the second connection arm 442 are consistent with an extension direction of the shell 100, thereby fully utilizing the internal space of the shell 100. Moreover, the second connection arm 442 has a convergence surface 4421, and the microphone 700 is electrically connected to the convergence surface 4421. Optionally, a circuit board may be disposed on the convergence surface 4421, and the microphone 700 may be connected to the circuit board on the convergence surface 4421 through a flexible circuit board, a wire, and the like, thereby achieving the electrical connection.

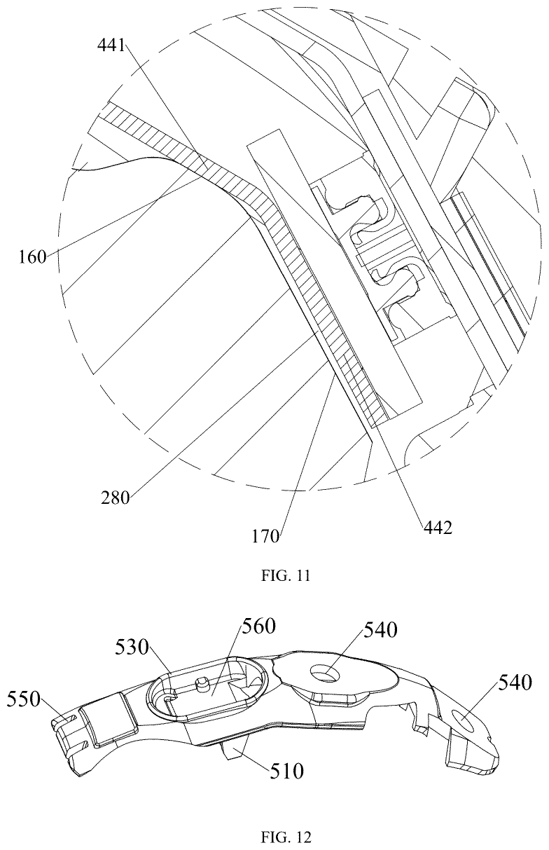

Optionally, as shown in FIG. 9, the support structure 200 is provided with a first support portion 260 and a first limit portion 270, and the first support portion 260 and the second limit portion are disposed on the support plate 290. The first support portion 260 and the second support portion are disposed towards the convergence portion 440. Specifically, as shown in FIG. 11, the first connection arm 441 is supported by the first support portion 260, thereby preventing the deformation of the first connection arm 441 and preventing the first connection arm 441 from moving relative to the support structure 200. The first limit portion 270 is disposed on a side of the second connection arm 442 facing away from the convergence surface 4421, and a movable gap 280 is formed between the first limit portion 270 and the second connection arm 442. The movable gap 280 is provided for the movement of the second connection arm 442, so that when the microphone 700 is connected to the convergence portion 440, the convergence portion 440 may have a certain movable space relative to the support structure 200 to compensate for the positional deviation between the convergence portion 440 and the microphone 700 and the dimensional deviation of the convergence portion 440 and the microphone 700, thereby reducing the assembly complexity of the hearing aid device.

In some optional embodiments, as shown in FIG. 2, the microphone 700 may be disposed on the antenna assembly 500 and disposed on a side of the antenna assembly 500 in the thickness direction of the antenna assembly 500, and a component for electrically connecting the microphone 700 to the convergence portion 440 may be disposed on the other side of the antenna assembly 500 in the thickness direction of the antenna assembly 500. In this case, as shown in FIG. 12, the antenna assembly 500 is also provided with a perforation 540 so that the convergence portion 440 and the microphone 700 may be electrically connected through the perforation 540. It is, of course, to be understood that the microphone 700 may also be connected to the shell 100, or the microphone 700 may also be connected to the support structure 200, which is not limited in this embodiment.

With continued reference to FIG. 12, one end of the antenna assembly 500 may also be provided with an engaging groove 550. As shown in FIG. 18, an engaging strip 180 matching the engaging groove 550 is disposed within the shell 100, and at least part of the engaging strip 180 is engaged with the engaging groove 550, thereby achieving the limiting of the antenna assembly 500 by the shell 100 and ensuring the fixed position of the antenna assembly 500 relative to the shell 100.

Optionally, in order to facilitate the control of functions or switches of the hearing aid device, optionally, as shown in FIG. 1, the hearing aid device further includes a button mechanism 800. As shown in FIG. 15, the shell 100 is provided with a button through-hole 160, the button through-hole 160 is configured to provide for the mounting of the button mechanism 800, and optionally, the button through-hole 160 may be disposed on the second housing 120.

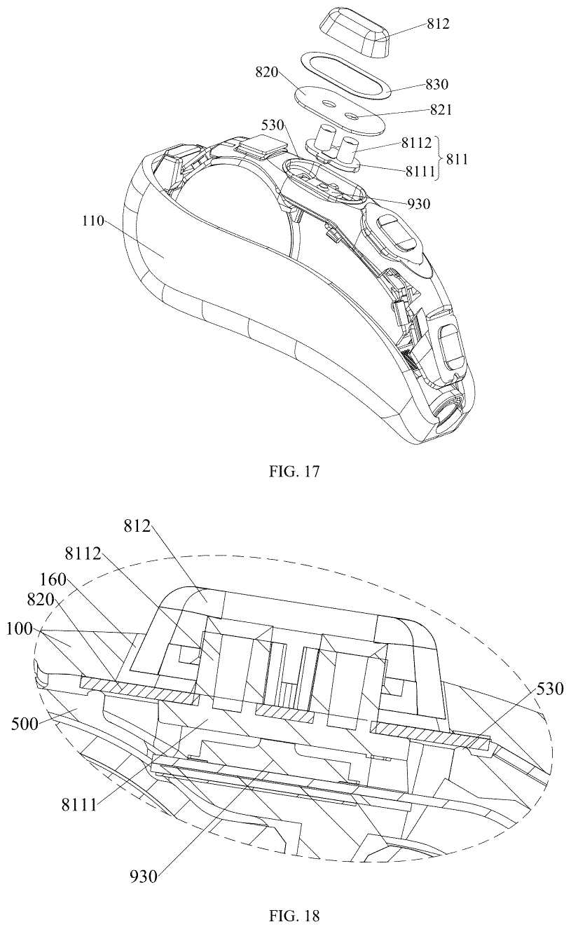

In order to improve the waterproof performance of the hearing aid device, exemplarily, as shown in FIG. 6, the button mechanism 800 includes a button assembly 810 and a waterproof structure 820. The button assembly 810 is movably disposed to pass through the button through-hole 160, and a portion, located within the shell 100, of the button assembly 810 may trigger a control switch 930 (such as, a press switch) within the shell 100. The triggering of the control switch 930 by the button assembly 810 may be accomplished by the button assembly 810 touching the press switch. As shown in FIGS. 17 and 18, the waterproof structure 820 is sleeved on the button assembly 810. In some optional embodiments, a position where the waterproof structure 820 is connected to the button assembly 810 is sealed, that is, the waterproof structure 820 is in close contact with the button assembly 810. A circumferential edge of the waterproof structure 820 is affixed and connected to the shell 100. The waterproof structure 820 is provided, the waterproof structure 820 is connected to the shell 100 and the waterproof structure 820 is connected to the button assembly 810, so that the interior of the shell 100 is separated from the external environment, thereby preventing the water and the like outside of the shell 100 from entering the shell 100 through the gap between the shell 100 and the button assembly 810, and improving the waterproof performance of the hearing aid device.

It is to be noted that the waterproof structure 820 in this embodiment is capable of elastic deformation, specifically, the waterproof structure 820 elastically deforms when the button assembly 810 moves relative to the shell 100. The waterproof structure 820 is provided so that when the button assembly 810 is pressed and moves relative to the shell 100, the waterproof structure 820 undergoes the elastic deformation, and the button assembly 810 will not be unable to move due to the pulling and tugging of the waterproof structure 820, thereby ensuring the function of the button assembly 810. Optionally, the waterproof structure 820 is made of an elastic material, for example, the waterproof structure 820 may be made of silicone, rubber, and the like, which is not limited in this embodiment.

Optionally, this embodiment provides a button assembly 810, as shown in FIGS. 17 and 18, the button assembly 810 includes a button 811 and a button cap 812. At least part of the button 811 is located within the shell 100 and is capable of triggering the control switch 930. At least part of the button cap 812 is slidably disposed in the button through-hole 160 and is connected to the button 811.

In an embodiment, as shown in FIG. 18, the waterproof structure 820 is located within the shell 100, and the circumferential edge of the waterproof structure 820 is affixed and connected to an inner wall of the shell 100. Moreover, the waterproof structure 820 is sleeved on the button 811 and is connected to the button 811. In some optional embodiments, as shown in FIG. 17, the waterproof structure 820 is provided with a waterproof hole 821, and a part of the button 811 is configured to pass through the waterproof hole 821 and is connected to a hole wall of the waterproof hole 821.

In other embodiments, the waterproof structure 820 may also be located outside the shell 100, and the circumferential edge of the waterproof structure 820 is affixed and connected to the outer wall of the shell 100, in this case, the waterproof structure 820 may be sleeved on the button cap 812 to seal the button assembly 810.

In some optional embodiments, the button cap 812 is connected to the button 811 by welding, for example, the button cap 812 is welded to the button 811 by ultrasonic welding, which is not limited in this embodiment.

In an optional embodiment, as shown in FIGS. 17 and 18, the button 811 includes a button body 8111 and a button protruding post 8112 connected to a side of the button body 8111. The button protruding post 8112 is connected to the button cap 812, and an end of the button protruding post 8112 facing away from the button body 8111 can extend into the button cap 812 and may be connected to the button cap 812 by ultrasonic welding. The waterproof structure 820 is sleeved on the button protruding post 8112, that is, the button protruding post 8112 is disposed to pass through the waterproof hole 821. Moreover, the waterproof structure 820 is located between the button body 8111 and the button cap 812. The button protruding post 8112 is provided, so that the connection between the button 811 and the button cap 812 is realized, and the connection area between the button 811 and the waterproof structure 820 is relatively small, thereby facilitating control of the sealing effect between the button 811 and the waterproof structure 820.

In some optional embodiments, in order to facilitate the assembly of the waterproof structure 820, as shown in FIG. 16, the inner wall of the shell 100 is provided with a shallow groove 170. In this embodiment, the shallow groove 170 is disposed on the second housing 120. Moreover, at least part of the waterproof structure 820 is located in the shallow groove 170. The shallow groove 170 is provided to facilitate the positioning and mounting of the waterproof structure 820, thereby ensuring that the waterproof structure 820 will not occupy too much space inside the shell 100.

In order to improve the sealing effect between the waterproof structure 820 and the inner wall of the shell 100, in some optional embodiments, the antenna assembly 500 is disposed close to the button assembly 810. Moreover, as shown in FIGS. 12 and 18, the antenna assembly 500 is provided with a pressing structure 530, and the pressing structure 530 abuts against the circumferential edge of the waterproof structure 820 and is configured to press the waterproof structure 820 against the shell 100, so that the waterproof structure 820 is limited, and the waterproof structure 820 may tightly contact with the inner wall of the shell 100 to further ensure the sealing and waterproofing effect.

Optionally, in order to improve the uniformity of the external force applied to the waterproof structure 820, in this embodiment, the pressing structure 530 is ring-shaped to increase the contact area between the pressing structure 530 and the waterproof structure 820. In some optional embodiments, the ring-shaped pressing structure 530 may sealingly abut against the waterproof structure 820 to form a double-sealing structure, thereby further enhancing the sealing effect of the hearing aid device.

In order to reduce the risk of separation of the waterproof structure 820 from the shell 100, optionally, as shown in FIG. 17, the circumferential edge of the waterproof structure 820 is affixed and connected to the inner wall of the shell 100 through the connection colloid 830. The connection colloid 830 is provided, so that the connection strength between the waterproof structure 820 and the shell 100 can be improved, and the connection colloid 830 can also provide the sealing effect. Exemplarily, the connection colloid 830 includes, but is not limited to, a backing gel.

Exemplarily, the hearing aid device may include a control switch 930, and as shown in FIG. 17, the control switch 930 is disposed within the shell 100, for example, the control switch 930 may be disposed on the antenna assembly 500. Movement of the button assembly 810 relative to the shell 100 can trigger the control switch 930. Optionally, as shown in FIG. 12, a surface of the antenna assembly 500 towards the button through-hole 160 may be provided with a switch groove 560, the control switch 930 is placed in the switch groove 560, and the pressing structure 530 surrounds the outer periphery of the switch groove 560.

In some optional embodiments, as shown in FIG. 2, the hearing aid device further includes a connector 920, and the connector 920 is configured to connect cables and the like. In this embodiment, the connector 920 is electrically connected to the mainboard body 410.

The hearing aid device provided in this embodiment has a simpler structure, which not only satisfies the requirements for miniaturization and lightweight, but also satisfies the requirements for waterproof. The mainboard body 410 is connected to the antenna assembly 500 in a more ingenious structure.

What is claimed is:

1. A hearing aid device, comprising:
a shell, comprising a first housing and a second housing which are connected to each other, wherein the first housing and the second housing are connected to each other to form an accommodation cavity;
a support structure, disposed within the accommodation cavity and provided with a semi-groove;
a battery assembly, wherein at least part of the battery assembly is located in the semi-groove; and
a mainboard assembly, comprising a mainboard body and an extension structure, wherein the mainboard body is disposed on the support structure, one end of the extension structure is connected to the mainboard body, another end of the extension structure is bent in a direction towards the battery assembly, the extension structure cooperates with the semi-groove to form a limit space for limiting the battery assembly, and the extension structure and/or the mainboard assembly are electrically connected to the battery assembly.

2. The hearing aid device of claim 1, wherein the mainboard body is disposed on a side of the battery assembly in a first direction, the extension structure is provided with an output terminal, the output terminal is located on another side of the battery assembly in the first direction and is configured to be electrically connected to a charging terminal of the hearing aid device, and every two of the first direction, a width direction of the shell and a thickness direction of the shell are perpendicular to each other.

3. The hearing aid device of claim 1, wherein the extension structure extends in a circumferential direction of the battery assembly;
the support structure is provided with a first enclosure barrier opposite to the battery assembly in a second direction and a second enclosure barrier extending in the circumferential direction of the battery assembly, the first enclosure barrier and the second enclosure barrier cooperate with each other to form the semi-groove, and the second direction is a thickness direction of the battery assembly.

4. The hearing aid device of claim 1, wherein the support structure is provided with a limit structure, and the mainboard body is connected to the support structure through the limit structure.

5. The hearing aid device of claim 4, wherein each of two sides of the support structure in a thickness direction of the support structure is provided with a limit structure, the mainboard body comprises a body portion and two side plate portions, the extension structure is connected to the body portion, the two side plate portions are connected to the body portion and are disposed on the two sides of the support structure in the thickness direction of the support structure, and each of the two side plate portions is connected to a limit structure on a respective one of the two sides of the support structure.

6. The hearing aid device according to claim 5, wherein each of the two side plate portions is provided with a limit-fit structure, and each limit-fit structure cooperates with a respective limit structure to limit a position of the mainboard body relative to the support structure.

7. The hearing aid device of claim 1, further comprising an antenna assembly, wherein the antenna assembly is disposed on the support structure and is electrically connected to the mainboard assembly.

8. The hearing aid device of claim 7, further comprising an elastic structure, wherein the elastic structure abuts against the antenna assembly and the mainboard assembly, and the antenna assembly is electrically connected to the mainboard assembly through the elastic structure.

9. The hearing aid device of claim 8, wherein the antenna assembly is provided with at least one external extension portion extending towards the support structure, at least one elastic structure is disposed between each external extension portion of the at least one external extension portion and the mainboard body, and each of the at least one elastic structure abuts against a respective extension portion of the at least one external extension portion and is electrically connected to the respective external extension portion.

10. The hearing aid device according to claim 9, wherein two external extension portions are provided, the support structure is provided with a positioning clamping groove, a positioning clamping block is disposed between the two external extension portions and is positioned in the positioning clamping groove, and the two external extension portions correspondingly contact two side walls of the support structure in a thickness direction of the support structure.

11. The hearing aid device according to claim 8, wherein the elastic structure comprises an elastic piece body, and a bent portion that is connected to one end of the elastic piece body and located on one side of the elastic piece body, and the bent portion has an abutting arc surface for contacting the antenna assembly or the mainboard assembly;
a sliding groove is provided on the one side of the elastic piece body facing the bent portion, a sliding block configured to abut against the elastic piece body is disposed at an end of the bent portion facing away from the elastic piece body, and the sliding block is slidably disposed in the sliding groove.

12. The hearing aid device according to claim 1, wherein the first housing is provided with a stepped structure, the second housing is provided with a boss matching the stepped structure, and a sealing colloid is provided between a stepped surface of the stepped structure and the boss; a support protrusion is disposed on a surface of the boss facing away from the second housing.

13. The hearing aid device according to claim 1, wherein an inner wall of the first housing is provided with a first welding body, an inner wall of the second housing is provided with a second welding body, and the first welding body and the second welding body are welded by ultrasonic welding.

14. The hearing aid device according to claim 13, wherein the first welding body extends into the second housing; and/or
a plurality of first welding bodies and a plurality of second welding bodies are provided, and the plurality of first welding bodies and the plurality of second welding bodies are disposed in a one-to-one correspondence.

15. The hearing aid device of claim 1, further comprising at least one microphone, wherein each of the at least one microphone corresponds to at least one sound hole on the shell, the at least one microphone is disposed within the shell, the mainboard assembly further comprises a convergence portion connected to the mainboard body, and the at least one microphone is electrically connected to the convergence portion.

16. The hearing aid device of claim 15, wherein the convergence portion comprises a first connection arm and a second connection arm which are connected to each other, the first connection arm is electrically connected to the mainboard body, the second connection arm and the first connection arm are disposed at an included angle to each other, the second connection arm has a convergence surface, and the at least one microphone is electrically connected to the convergence surface; and
the support structure is provided with a first support portion and a first limit portion, the first connection arm is supported by the first support portion, the first limit portion is disposed on a side of the second connection arm facing away from the convergence surface, and a movable gap is formed between the first limit portion and the second connection arm.

17. The hearing aid device according to claim 15, further comprising an antenna assembly, wherein the antenna assembly is disposed in the accommodation cavity and is limited between the support structure and the shell; the at least one microphone is disposed on the antenna assembly.

18. The hearing aid device according to claim 1, further comprising a button mechanism, wherein the shell is provided with a button through-hole, the button mechanism comprises a button assembly and an elastic waterproof structure, the button assembly is configured to movably pass through the button through-hole, and a portion of the button assembly located inside the shell is configured to trigger a control switch inside the shell; the elastic waterproof structure is sleeved on the button assembly and is sealingly connected to the button assembly, and a circumferential edge of the elastic waterproof structure is sealingly connected to the shell; the button assembly is configured to move relative to the shell to pull the elastic waterproof structure to elastically deform.

19. The hearing aid device according to claim 18, further comprising an antenna assembly, the antenna assembly is disposed in the accommodation cavity and is limited between the support structure and the shell; the antenna assembly is provided with a pressing structure, and the pressing structure is configured to abut against the circumferential edge of the elastic waterproof structure and to press the elastic waterproof structure against the shell.

20. The hearing aid device according to claim 18, wherein the button assembly comprises a button and a button cap, at least part of the button is located inside the shell and is configured to trigger the control switch; at least part of the button cap is slidably disposed in the button through-hole and connected to the button; the elastic waterproof structure is located inside the shell, the circumferential edge of the elastic waterproof structure is sealingly connected to an inner wall of the shell, and the elastic waterproof structure is sleeved on the button and is sealingly connected to the button.
